(19) United States
(12) Patent Application Publication
(10) Pub. No.: US 2018/0187776 A1
(43) Pub. Date: Jul. 5, 2018

(54) ACTUATOR UNIT FOR A VEHICLE

(71) Applicant: Schaeffler Technologies AG & Co. KG, Herzogenaurach (DE)

(72) Inventors: Martin ZIMMERMANN, Sasbach (DE); Bruno MÜLLER, Sasbach (DE); Jürgen GERHART, Appenweier (DE)

(73) Assignee: Schaeffler Technologies AG & Co. KG, Herzogenaurach (DE)

(21) Appl. No.: 15/739,296

(22) PCT Filed: May 31, 2016
(86) PCT No.: PCT/DE2016/200258

§ 371 Date: Dec. 22, 2017

(30) Foreign Application Priority Data
Jun. 30, 2015 (DE) 10 2015 212 126.7

(51) Int. Cl. F16H 61/00; F16H 61/34; F16H 61/28; F16H 61/32; F16H 3/00; F16H 61/688

(52) U.S. Cl. CPC F16H 61/0006; F16H 61/34; F16H 61/2807; F16H 2003/007; F16H 3/006; F16H 61/688; F16H 2061/2823; F16H 61/32

(57) ABSTRACT

A control device within an actuator includes control logic for a second actuator, the second actuator being connected with the first actuator through a communications interface. By storing the control logic in the second actuator, the construction space for this second actuator is optimized. By integrating the control logic into a control device of the first actuator, the power density of the control device is increased.

### CROSS-REFERENCE TO RELATED APPLICATIONS

This application is the United States National Phase of PCT Appln. No. PCT/DE2016/200258 filed May 31, 2016, which claims priority to German Application No. DE102015212126.7 filed Jun. 30, 2015, the entire disclosures of which are incorporated by reference herein.

### TECHNICAL FIELD

The present disclosure relates to an actuator unit for a vehicle, comprising a first actuator having a control device within the actuator to actuate power electronics of the actuator, and a communications interface.

### BACKGROUND

From DE 10 2011 010 512 A1 a smart actuator for operating a clutch is known, having a communications interface for connecting to a superordinate control device and a data line for connecting to the superordinate control device. In this case, the smart actuator comprises an internal control device, which is connected to the final stages of the clutch control system.

Due to the size of the control device, such an actuator system also requires in particular considerable construction space.

Thus there is a long-felt need for an actuator unit which is optimized with regard to construction space.

### BRIEF SUMMARY

According to the present disclosure, the control device within the actuator includes control logic for a second actuator, the second actuator being connected with the first actuator through the communications interface. By storing the control logic in the second actuator, the construction space for this second actuator is optimized. By integrating the control logic into the control device of the first actuator, the power density of the control device is increased.

Advantageously, the communications interface is connected to an arithmetic-logic unit integrated into the second actuator, to convert the control signals emitted by the control device of the first actuator into triggering signals for the second actuator. This limits the electronics required in the second actuator, resulting in a cost-effective design of the second actuator.

Advantageously, the first and the second actuator have an independent power supply. This ensures that both actuators are able to operate self-sufficiently.

In a variant, the first actuator is designed as a clutch actuator and the second actuator as a transmission actuator, the clutch actuator being connected to an external data line and/or to a line carrying a rotation speed signal and/or to a line present at an accelerator pedal to provide input signals for the control device. Since these input signals only have to be provided once for the clutch actuator in order to also produce control signals for the transmission actuator, the design environment of the transmission actuator is simplified.

In one embodiment, the arithmetic-logic unit of the transmission actuator is connected via one final power stage each to a shifting motor and a selector motor of the transmission actuator. This has the advantage that it is also possible to actuate the selector motor and shifting motor of the transmission actuator using just one clutch actuator, since the control logic of the control device of the clutch actuator can be adapted accordingly. This further simplifies the construction of the transmission actuator.

In an example embodiment, the clutch actuator is connected directly to the selector motor through a first communications interface and directly to the shifting motor of the transmission actuator through a second communications interface. This makes a separate transmission unit possible, which is simplified overall in its construction and is optimized with regard to construction space.

In an alternative, the transmission actuator includes a shift intent detection unit to detect a shifting procedure performed manually on a separate gear set, where the clutch actuator provides a voltage supply for the shift intent detection unit. With more simply constructed transmission actuators also, which form what is known as an electronic clutch management system with the clutch actuator, a simplification of the clutch actuator can be achieved by locating the power supply for the sensors of the shift intent detection unit in the clutch actuator.

Alternatively, the actuator unit is designed as a dual-clutch transmission, in which a clutch actuator is provided for each sub-transmission actuator to trigger the arithmetic-logic unit of the sub-transmission actuator, where the arithmetic-logic unit actuates the selector motor and the shifting motor of the sub-transmission actuator through the respective final power stage. This permits the multiple use of a ready-made clutch actuator which includes an internal control device, for different transmission assemblies.

In a an example embodiment, each clutch actuator is connected to the shifting motor of the sub-transmission actuator through the first communications interface and to the selector motor of the same sub-transmission actuator through the second communications interface. In this case, it is possible to completely dispense with electronics in the sub-transmission actuator, since the clutch actuator operates the individual actuators of the transmission actuator in the form of the shifting and selector motor separately from one another. For this as well, only a single clutch actuator is needed.

In one embodiment, for a hydraulic actuation of the transmission actuator by the clutch actuator, an interface between clutch actuator and transmission actuator transmits two control signals from the clutch actuator to the transmission actuator, and two additional signals having position information from the transmission actuator to the clutch actuator. This results in an additional use for the preconditioned actuator, which includes an internal control device.

### BRIEF DESCRIPTION OF THE DRAWINGS

The present disclosure allows numerous embodiments. Several of these are explained in greater detail in the figures depicted in the drawing.

The figures show the following:

FIG. 1 a first exemplary embodiment of an actuator unit according to the present disclosure,

FIG. 2 another exemplary embodiment of the actuator unit according to the present disclosure,

FIG. 3 another exemplary embodiment of the actuator unit according to the present disclosure,

FIG. 4 another exemplary embodiment of the actuator unit according to the present disclosure,

FIG. 5 another exemplary embodiment of the actuator unit according to the present disclosure.

### DETAILED DESCRIPTION

Like features are identified by the same reference labels.

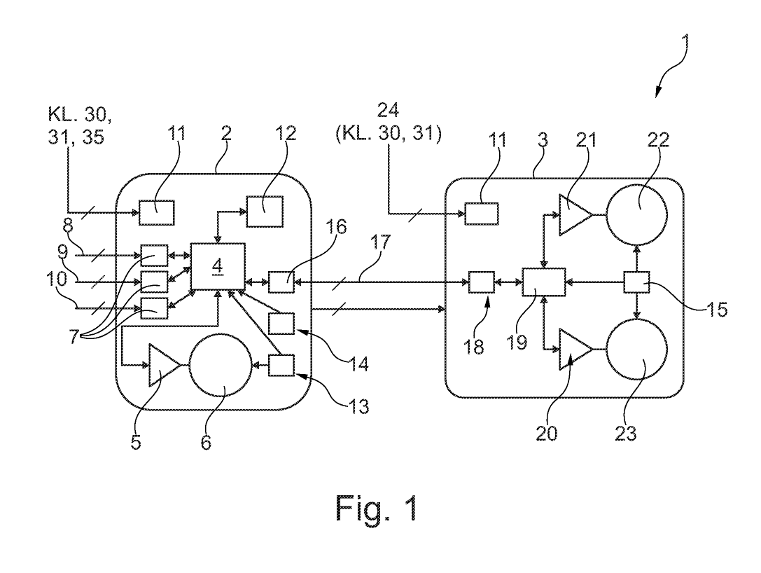

FIG. 1 depicts a first exemplary embodiment of the actuator unit 1 according to the present disclosure, which consists of a clutch actuator 2 and a transmission actuator 3. The modular clutch actuator 2 includes a control device 4, which is connected to a final stage 5 of an electric motor 6. The control device 4 is connected through various driver interfaces 7 to a plurality of external lines which provide input signals. Such an input signal is provided, for example, through a CAN bus 8 of the vehicle. A rotation speed signal from a rotation speed sensor is transmitted to the control device 4 via the line 9, and the control device 4 is connected to a clutch pedal via the line 10. At the same time, the clutch actuator 2 is supplied with energy, by connecting a reverse polarity protector 11 of the clutch actuator 2 to terminals 30, 31 and 15 of the vehicle. The final stage 5 for driving the electric motor 6, which operates a clutch (not shown in further detail) is designed here as a B6 bridge. The functioning of the control device 4 is monitored by means of a watchdog circuit 12. At the same time, various sensors, for example rotor position sensors 13, absolute distance sensors 14 or various Hall effect sensors 15, monitor the electric motor 6.

The control device 4 is connected to the transmission actuator by means of an additional driver circuit 16 and a bidirectional communications interface 17. In this case, the transmission actuator 3 has a driver circuit 18 of its own, which leads to an arithmetic-logic unit 19, which actuates the two final stages 20, 21, which operate a shifting motor 22 and a selector motor 23 of the transmission actuator 3, respectively. The actual control logic for the transmission actuator 3 is integrated into the control device 4 of the clutch actuator 2, which provides the control signals for the transmission actuator 3 on the basis of the input signals it receives, for which reason the arithmetic-logic unit 19 within the transmission actuator 3 converts the control signals received from the clutch actuator 2 into direct triggering signals for the shifting and selector motors 22, 23. The transmission actuator 3 likewise has an independent power supply 24.

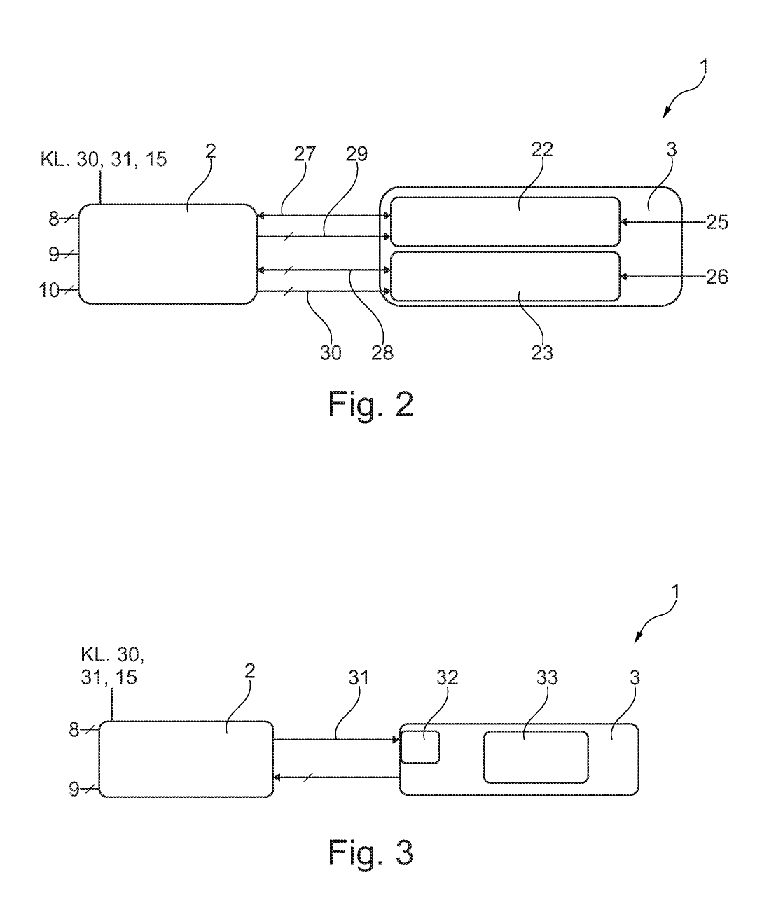

FIG. 2 shows another exemplary embodiment of the actuator unit 1 according to the present disclosure, wherein the clutch actuator 2 receives input signals as described in connection with FIG. 1. The transmission actuator 3 consists here of the separately controllable shifting motor 22 and the separately controllable selector motor 23, each of which is connected to a respective power supply 25, 26. The clutch actuator 2 is connected to the shifting motor 22 through a first bidirectional communications interface 27, while the same clutch actuator 2 is connected to the selector motor 23 through a second communications interface 28, which is likewise bidirectional. To be able to shut off the shifting motor 22 or the selector motor 23 in the event of a fault, the clutch actuator 2 is connected to the shifting motor 22 and the selector motor 23 by means of safety lines 29, 30 respectively.

Another exemplary embodiment of the actuator unit 1 according to the present disclosure is depicted in FIG. 3. Here, to receive input signals, the clutch actuator 2 is connected to the CAN bus 8 and to the line 9, which connects the clutch actuator to the rotation speed sensor. Also present at this clutch actuator 2 is a power supply. The clutch actuator 2 supplies a shift intent detection unit 32 of the clutch actuator 3 with voltage (5V) by means of a power supply line 31. A transmission 33 sends a signal to the clutch actuator 2 when a shifting of the transmission 33 has occurred. In this case too, the control logic for the transmission 33 is stored in the control device 4 of the clutch actuator 2, so that no expensive electronics are required in the transmission 33.

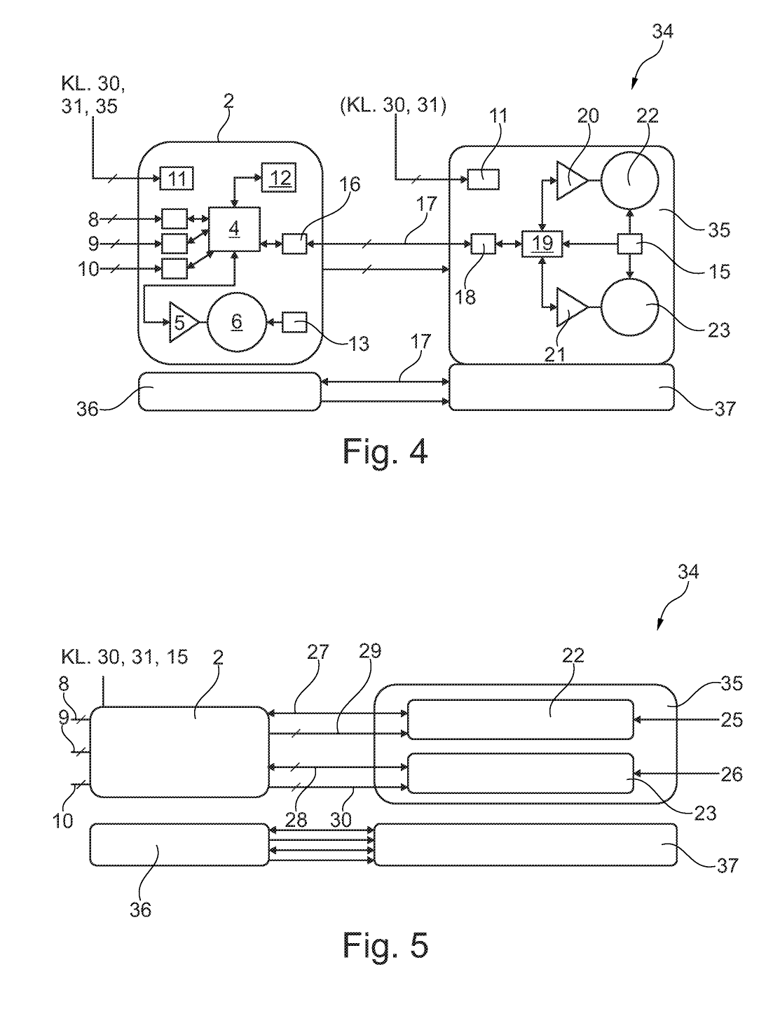

FIGS. 4 and 5 describe additional exemplary embodiments of the clutch actuator 1 according to the present disclosure, in the form of a dual-clutch transmission 34. In such a dual-clutch transmission 34, even and uneven gears are supported separately in a transmission housing on shafts supported inside one another. These two shafts are clutched separately by two clutches, which are likewise nested in one another. When changing gears, the desired gear is first selected on the shaft whose clutch is disengaged. This clutch is then continuously engaged, while at the same time the other clutch is continuously disengaged. The actuation occurs electively using electric motors or by means of an electrohydraulic control.

For each sub-transmission actuator 35, 37, a clutch actuator 2, 36 is needed, which actuates the shifting motor 22 or the selector motor 23 of the sub-transmission actuator 35, 37, since the control logic for these two motors 22, 23 is stored in the control device 4 of the clutch actuator 2, 36. In this case, the clutch actuator 2 is connected through a bidirectional communications interface 17 to the sub-transmission actuator 35, 37, which in turn has an arithmetic-logic unit 19 to convert the control signals of the control device 4 into actuating signals for the shifting motor 22 or the selector motor 23. In the interest of clarity, FIG. 4 depicts only one clutch actuator 2 and the associated sub-transmission actuator 35 for one sub-transmission line of the dual-clutch transmission 34. The second clutch actuator 36 and the second sub-transmission actuator 37 are only hinted at.

According to FIG. 5, in a dual-clutch transmission 34 as well, the same clutch actuator 2, 36 may directly actuate the respective shifting or selector motor 22, 23 of the respective sub-transmission actuator 35, 37. This results in even more of the control logic of the dual-clutch transmission 34 being stored in the control device 4 of the clutch actuator 2, while a single clutch actuator 2 is used to actuate the shifting motor 22 as well as the selector motor 23 of the respective sub-transmission actuator 35, 37. Here, the clutch actuator 2 is connected to the shifting motor 22 through the first bidirectional communications interface 27 and through a safety line 29, to shut it off in the event of a fault. In exactly the same way, the selector motor 23 is connected to the clutch actuator 2 through the second bidirectional communications interface 28 and the unidirectional safety line 30. The second clutch actuator 36 is connected to the second sub-transmission actuator 37 in a comparable manner.

The possibility also exists, however, that the modularly constructed clutch actuator 2, 35 forms one actuator unit 1 with one transmission actuator, which has a control device of its own. In this case, no direct communication between both actuators is necessary.

The described design of the clutch actuator 2 according to the present disclosure can also be used with a hydraulic transmission actuating system, in particular in connection with FIGS. 1, 2, 3 and 4. In this case, proportional valves are used instead of the electric motors 22, 23 in the transmission actuator. The communications interface between the clutch actuator 2 and the transmission actuator 3 transmits two PWM signals from the clutch actuator 2 to the transmission actuator 3, for shifting and selecting. From the transmission actuator 3 to the clutch actuator 2 two additional signals are transmitted, which may also have the form of PWM signals, for position information.

The described clutch actuator 2 may also be used as a parking lock actuator, or as the actuator for a disconnect clutch in hybrid vehicles.

On the basis of the described solution, it is possible to use a ready-made clutch actuator which includes an internal control device in many ways for different transmission assemblies, and to couple it with transmission actuators of different designs.

### REFERENCE LABELS

1 actuator unit
2 clutch actuator
3 transmission actuator
4 control device
5 final stage
6 electric motor
7 driver interface
8 CAN bus
9 line
10 line
11 reverse polarity protector
12 watchdog circuit
13 rotor position sensor
14 absolute distance sensor
15 Hall effect sensor
16 driver circuit
17 communications interface
18 driver circuit
19 arithmetic-logic unit
20 final stage
21 final stage
22 shifting motor
23 selector motor
24 power supply
25 power supply
26 power supply
27 communications interface
28 communications interface
29 safety line
30 safety line
31 power supply line
32 shift intent detection unit
33 transmission
34 dual-clutch transmission
35 sub-transmission actuator
36 clutch actuator
37 sub-transmission actuator

1.-10. (canceled)

11. An actuator unit for a vehicle, comprising:
a first actuator including power electronics;
a control device within the first actuator for actuating the power electronics of the first actuator, and including a control logic for a second actuator; and,
a communications interface for connecting the first actuator to the second actuator.

12. The actuator unit according to claim 11, further comprising:
the second actuator; and,
an arithmetic-logic unit integrated into the second actuator, wherein the communications interface is connected to the arithmetic-logic unit for converting a control signal emitted by the control device into a triggering signal for the second actuator.

13. The actuator unit according to claim 12, wherein the first actuator and the second actuator each have an independent power supply.

14. The actuator unit according to claim 12, wherein:
the first actuator is a clutch actuator; and,
the second actuator is a transmission actuator.

15. The actuator unit according to claim 14, wherein:
the second actuator includes a shift intent detection unit to detect a manually performed shifting procedure; and,
the first actuator provides a voltage supply to the shift intent detection unit.

16. The actuator unit according to claim 12, wherein:
the first actuator is a clutch actuator connected to an external data line or a line carrying a rotation speed signal or a line present at an accelerator pedal to provide an input signal for the control device; and,
the second actuator is a transmission actuator.

17. An actuator unit according to claim 12, wherein:
the second actuator comprises a shifting motor and a selector motor; and,
the arithmetic-logic unit is connected via a final power stage to the shifting motor and the selector motor.

18. The actuator unit according to claim 17, wherein the communications interface comprises:
a first communications interface for connecting the first actuator to the shifting motor; and,
a second communications interface for connecting the first actuator to the selector motor.

19. A dual-clutch transmission comprising:
a first actuator unit according to claim 17 for operating on a first sub-transmission of the dual-clutch transmission; and,
a second actuator unit according to claim 17 for operating on a second sub-transmission of the dual-clutch transmission.

20. The dual-clutch transmission according to claim 19, wherein:
the first actuator unit communications interface comprises:
a first actuator unit first communications interface for connecting the first actuator unit first actuator to the first actuator unit shifting motor;
a first actuator unit second communications interface for connecting the first actuator unit first actuator to the first actuator unit selector motor; and,
the second actuator unit communications interface comprises:
a second actuator unit first communications interface for connecting the second actuator unit first actuator to the second actuator unit shifting motor; and,
a second actuator unit second communications interface for connecting the second actuator unit first actuator to the second actuator unit selector motor.

21. The actuator unit of claim 11, wherein:
the second actuator is arranged for hydraulic actuation by the first actuator; and,
the communications interface is arranged to transmit two control signals from the first actuator to the second actuator, and two additional signals with position information from the second actuator to the first actuator.
